(19) United States
(12) Patent Application Publication
(10) Pub. No.: US 2005/0197818 A1
(43) Pub. Date: Sep. 8, 2005

(54) Virtual presence system and method

(76) Inventors: Akbar Monfared, Placerville, CA (US); Michael K. Sims, Auburn, CA (US); Glen Garland, Placerville, CA (US); Rex Schrader, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,063

(22) Filed: Jan. 30, 2004

(51) Int. Cl. G06F 13/12

(52) U.S. Cl. 703/21

(57) ABSTRACT

A virtual presence station may be positioned at a desired physical location and operates to communicate over a communications network with a remote user and with a unit under test and/or a test controller. The virtual presence station operates to communicate data to the remote user that is a function of the physical position of the virtual presence station, and further operates responsive to data from a remote user to control the test controller and/or the unit under test. The virtual presence station may include a computer, a high-resolution digital camera, a network Web camera, a wireless telephone, a test area, a portable cart, and a portable power source.

### TECHNICAL FIELD

The present invention relates generally to electronic systems, and more specifically to accessing electronic systems in remote locations to detect and repair problems in such systems.

### BACKGROUND OF THE INVENTION

Today's large corporations are typically multinational companies, having facilities in countries throughout the world and multiple facilities within individual countries. A large electronics company such as Hewlett Packard, for example, has engineering, manufacturing, administrative, and sales facilities throughout the United States and in foreign countries. Manufacturing facilities in particular are many times located in foreign countries where labor costs are low to thereby lower the cost of manufacturing products.

While locating manufacturing facilities in foreign countries makes sense from a business perspective, it may present challenges from an engineering and manufacturing standpoint. For example, engineers that designed a particular product may be located in a country other than the country where the product is being manufactured. As a result, if problems are encountered during the manufacture of such a product, an engineer or engineers remote from the manufacturing facility have the expertise required to troubleshoot and solve the problem. Relatively simple problems may be solved via telephone and email, but more complex problems typically require an engineer be physically present at the manufacturing site to monitor the actual manufacturing process and troubleshoot defective products. Thus, flying an engineer from a design facility to a manufacturing facility to troubleshoot problems is the only viable solution when more difficult manufacturing or other technical problems arise at remote facilities.

Physically requiring engineers or other technical personnel to travel to remote facilities and troubleshoot problems has several drawbacks. First, such travel is subject to worldwide events like a war or the Sudden Acute Respiratory Syndrome (SARS) outbreak, which are beyond the control of the corporation and may delay or prevent such travel. In many situations, several days delay could be extremely costly to a company if no product can be manufactured during this time. Another problem may arise due to cultural differences between employees at the remote site and the remote personnel, which may hamper efficient resolution of the problem.

Current remote technical solutions, such as video conferencing, are not an option in many situations since they are constrained to a particular location at the manufacturing site and do not allow remote personnel to view the actual manufacture of products or the actual hardware presenting a problem. Moreover, such technical solutions do not allow remote personnel to take control of remote systems, which is many times helpful in the troubleshooting process.

There is a need for providing remote personnel with comprehensive information and control of remote systems to allow the personnel to remotely detect and correct problems at remote sites.

### SUMMARY OF THE INVENTION

According to one aspect of the present invention, a virtual presence station may be positioned at a desired physical location and operates to communicate over a communications network with a remote user and with a unit under test and/or a test controller. The virtual presence station operates to communicate data to the remote user that is a function of the physical position of the virtual presence station, and further operates responsive to data from a remote user to control the test controller and/or the unit under test. The virtual presence station may include a computer, a high-resolution digital camera, a network Web camera, a wireless telephone, a test area, a portable cart, and a portable power source.

### BRIEF DESCRIPTION OF THE DRAWINGS

FIG. 1 is functional block diagram of a virtual presence station in a local manufacturing network that allows a remote engineer to detect and repair problems at the local site.

FIG. 2 is an isometric view of one embodiment of the virtual presence station of FIG. 1.

### DETAILED DESCRIPTION OF PREFERRED EMBODIMENTS

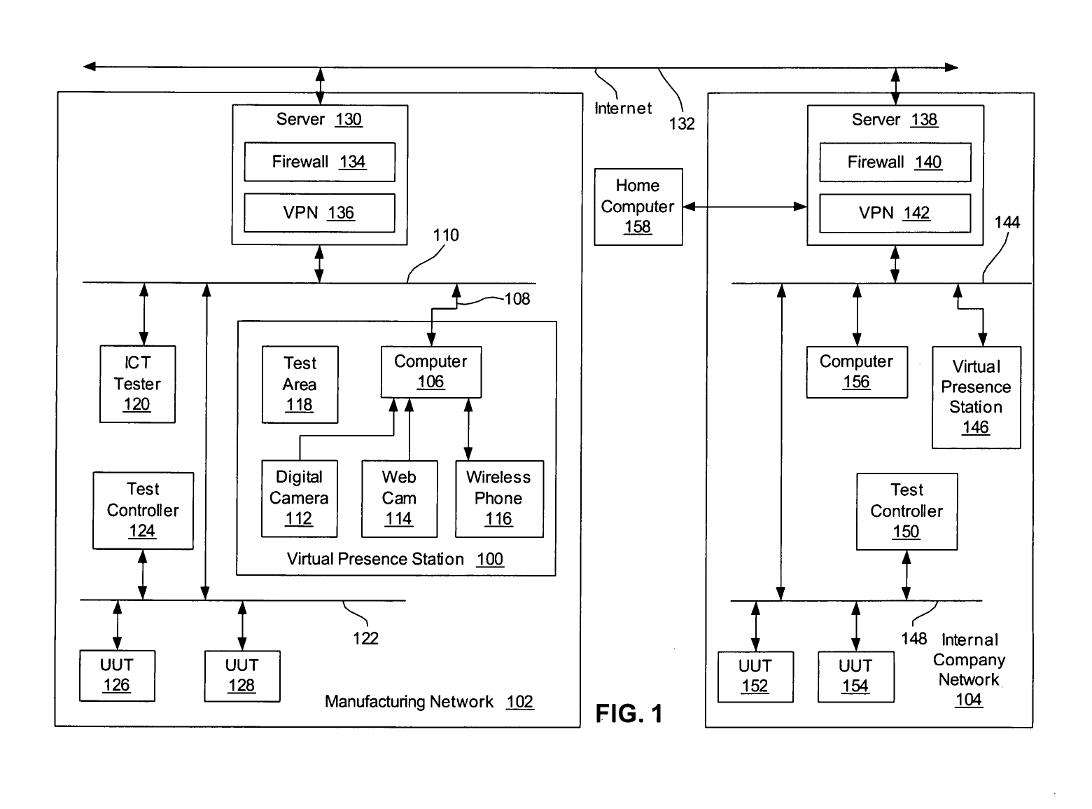

FIG. 1 is functional block diagram of a remote engineering or virtual presence station 100 contained in a local manufacturing network 102 that allows remote technical personnel such as engineers to detect and repair problems at the local manufacturing network without physically traveling to the site of the network. Engineers at the site of the manufacturing network 102 position the virtual presence station 100 to provide the remote engineer with location-specific audio and video information, and in this way provide the remote engineer with a “virtual” presence at the local manufacturing network. Through an internal company network 104, the remote engineer can communicate with the manufacturing network 102 and use the virtual presence station 100 to control devices in the network, allowing the remote engineer to directly repair problems without the need of further action from the local engineers in many cases.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail below to avoid unnecessarily obscuring the present invention.

The virtual presence station 100 includes a computer 106, which would typically be a laptop computer for portability, to allow a local engineer at the manufacturing network 102 to communicate via a wireless link 108 with a local area network 110. A digital camera 112 or other suitable high resolution digital image capture system is coupled to the computer 106 to allow the local engineer to capture high resolution digital images of units being tested. A network Web camera 114 or other low resolution digital video image capture system is also coupled to the computer to capture video images that provide the remote engineer with information regarding the physical location of the virtual presence station 100. The remote engineer may remotely control the network Web camera 114 to orient the camera to a desired position to thereby provide the remote engineer with desired video images. Alternatively, the local engineer may position the network Web camera 114 to the proper orientation to capture the desired video images. Digital images captured by both the digital camera 112 and network Web camera 114 are communicated to the remote engineer via the computer 106 and LAN 110, as will be described in more detail below.

The virtual presence station 100 further includes a wireless phone 116 coupled to the computer 106 to provide for audio communication between the local engineer and the remote engineer. This enables the remote engineer to, for example, provide the local engineer with instructions as to orientation of the network Web camera 114 so that the remote engineer can see the units being tested. A test area 118 provides the local engineer with a work area for units being tested, such as for positioning a circuit board or other unit being tested for viewing by the network Web camera 114 or to capture a high resolution digital image with the camera 112. The test area 118 may include, for example, an electrostatic discharge (ESD) mat and associated grounding equipment to allow the local engineer to safely work on circuit boards and other electronic equipment.

In the example of FIG. 1, the manufacturing network 102 includes an integrated circuit test (ICT) tester 120 coupled to the LAN 110. The ICT tester 120 typically includes a bed of contact points that provide electrical interconnection to a printed circuit board being tested and which allows individual integrated circuits contained on a circuit board to be tested, as will be appreciated by those skilled in the art. The LAN 110 is coupled to another LAN 122 including a test controller 124 that communicates over the LAN to test one or more units under test (UUT) 126 and 128, with two such units under test been shown by way of example. As used herein, the units under test 126 and 128 may be any component being tested, such as a circuit board or a device including multiple printed circuit boards. The test controller 124 typically performs functional unit testing (FUT) of the units under test 126 and 128, which is functional testing of components within each unit under test at a system board level. For example, were each unit under test 126 and 128 includes a number of circuit boards, the test controller 124 operates to perform functional unit testing to verify proper operation of each of these circuit boards. When the test controller 124 determines a circuit board is defective, the ICT tester 120 is thereafter utilized to determine the specific defect of the circuit board.

The test controller 124 and ICT tester 120 may be any of a variety of different types of suitable electronics testers, and will depend upon the specific units under test 126 and 128 being manufactured and tested at the facility containing the manufacturing network 102. The test controller 124 may, for example, be a controller using the Hewlett-Packard Computer Manufacturing Standard Test Architecture (“CMstar”). Also, the computer 106 in the station 100 will of course include appropriate software to allow the computer to communicate with and control the ICT tester 120 and test controller 124. For example, the tester 120 and controller 124 may run the Unix operating system while the computer 106 would typically be a laptop running a Windows operating system. In this situation, the computer 106 may include a software program such as Reflection X, which is a terminal emulation program that allows the local engineer using the computer to control graphical and character-based X Window applications running on UNIX in the ICT tester 120 and test controller 124, as will be appreciated by those skilled in the art.

The manufacturing network 102 further includes a server 130 that provides communication with the internal company network 104 over the Internet 132 or other suitable communications network. The server 130 includes a firewall 134 that operates to prevent access by unauthorized users of the manufacturing network 102 over the Internet 132, and also to control the access of users on the manufacturing network to resources on the Internet. The server 130 further includes a virtual private network (VPN) component 136 that operates to create a virtual private network between the manufacturing network 102 and the internal company network 104, as will be described in more detail below. The VPN component 136 and firewall 134 operate in combination create the virtual private network, with the firewall controlling access to and from the manufacturing network 102 and the VPN component encrypting messages and typically providing other security features, as will be understood by those skilled in the art.

The internal company network 104 corresponds to a network that is geographically remote from the manufacturing network 102. For example, the internal company network 104 may be the network at an engineering facility of a corporation while the manufacturing network 102 corresponds to the network at a contract manufacturer or configure to order site associated with the corporation. The internal company network 104 includes a server 138, firewall 140, and VPN component 142 that operate in the same way as previously described for the server 130, firewall 134, and VPN 136. The servers 130 and 138 and the corresponding firewalls 134 and 140 and VPN components 136 and 142 operate in combination to form a virtual private network between the manufacturing network 102 and the internal company network 104.

The internal company network 104 further includes a LAN 144 coupled to the server 138, a second virtual presence station 146, and a second LAN 148 including a test controller 150 and the units under test 152 and 154. Each of these components 144-154 operates in the same way as the corresponding component in the manufacturing network 102, and thus, for the sake of brevity, will not again be described in detail. A computer 156 in the network 104 allows a remote engineer to communicate over the virtual private network between the networks 102 and 104 with the computer 106 in the virtual presence station 100 to control the ICT tester 120 and test controller 124. The virtual presence station 146 in the internal company network 104 provides an engineer at this facility with the same type of functionality as the station 100 to access and test the units under test 152 and 154 that are remote from the computer 156 used by the engineer.

As previously mentioned, the manufacturing network 102 is geographically remote from the internal company network 104 and thus many times these networks may be in different time zones. As a result, it may be convenient for remote engineers at the internal company network 104 to access the internal company network from home or from some other remote location. A home computer 158 communicates through the server 138 to provide a remote engineer with access to the internal company network 104 and, in turn, with access to the manufacturing network 102. Suitable VPN software is executed on the home computer 158 and server 138 to maintain the security of the virtual private network between the networks 102 and 104. The home computer 158 allows the remote engineer to communicate with the virtual presence station 100 in the manufacturing network 102 from home at a convenient time for local engineers at the manufacturing network but perhaps not such a convenient time for the remote engineer, such as very early in the morning are very late at night in the time zone of the remote engineer and the internal company network 104.

In operation, local engineers at the manufacturing network 102 and remote engineers at the internal company network 104 would initially communicate to arrange a time for testing the units under test 126 and 128 at the manufacturing network. The local engineers would thereafter position the virtual presence station 100 in an appropriate location and the remote engineer would thereafter typically control the network Web camera 114 to provide the remote engineer with required visual information, such as a particular view of a manufacturing process or a view of the units under test 126 and 128. During this time, the local engineer and the remote engineer may communicate real-time audio information via the wireless phone 116. Depending on the situation, either the local engineer or the remote engineer may control the ICT tester 120 or test controller 124 to perform required testing of the units under test 126 and 128. For example, the local engineer may utilize the computer 106 to control the ICT tester 120 and test controller 124, while the remote engineer may utilize the computer 156 to communicate with the computer 106 in the virtual presence station 100 to thereby control the ICT tester and test controller.

The virtual presence station 100 provides real-time audio and video information to the remote engineer to allow that engineer to detect and fix problems with the units under test 126 and 128 without actually being at the site of the manufacturing network 102. Moreover, the remote engineer can directly control the ICT tester 120 and test controller 124 in the process of testing the units under test 126 and 128. All communications between the remote engineer and local engineer take place over the virtual private network between the manufacturing network 102 and internal company network 104, and are thus secure. With the virtual presence station 100, the need for remote engineers having particular expertise to physically travel to the site of the manufacturing network 102 should be greatly reduced, which should provide significant cost savings to the corporation. A single trip to a distant site can easily cost several thousands of dollars, while the cost of the virtual presence station should be recouped by the elimination of a small number of trips. For example, if the virtual presence station 100 costs $5000 and a typical trip by a remote engineer costs $2500, the station need eliminate only two trips to have paid for the cost of the station.

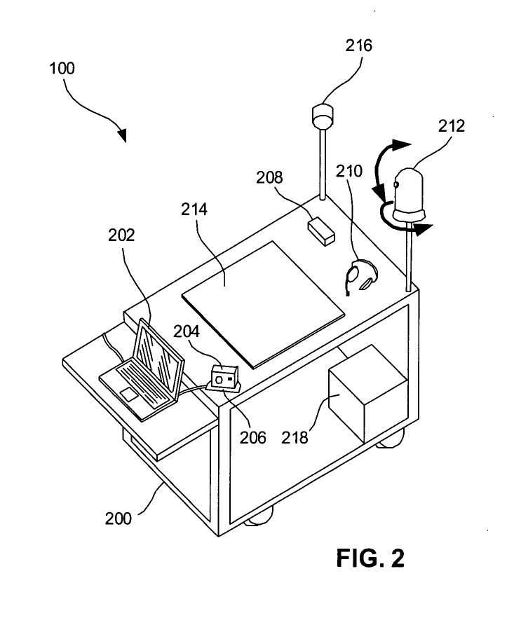

FIG. 2 is an isometric view of one embodiment of the virtual presence station 100 of FIG. 1. The station 100 includes a cart 200 that allows the station to be easily transported from one location to another at the site of the network 102 or 104. A laptop computer 202 corresponds to the computer 106 and is positioned on an upper surface of the cart 200. The computer 202 includes a wireless card (not shown) to communicate with the LAN 110 (FIG. 1) over the wireless link 108 (FIG. 1). A digital camera 204 is coupled to the computer 202 through a docking station 206 positioned on the upper surface of the cart 200. A phone 208 communicates to the computer 202 via a wireless link to allow the local engineer to talk to a remote engineer. A wireless headset 210 communicates with the phone 208 through a wireless link and allows the local engineer to talk to the remote engineer while having both hands free to perform required tasks. The phone 208 and wireless headset 210 are shown placed on the upper surface of the cart 200, as they may be when not in use.

A low-resolution camera 212 corresponding to the network Web camera 114 is positioned in a corner of the upper surface of the cart 200, and is elevated from the upper surface to provide a view of desired objects and to provide an appropriate view of an ESD mat 214 corresponding to the test area 118. Various accessories associated with the ESD mat 214, such as grounding straps, are not shown. A light 216 is positioned in a corner of the upper surface of the cart 200 to illuminate the ESD mat 214. The virtual presence station 100 further includes a battery 218 positioned on a lower surface of the cart 200 and coupled (not shown) to various components of the station such as the computer 202. The battery 218 provides required electrical power to the components 202-216 to make the station 100 portable without regard to positioning the cart 200 near an electrical power source for these components.

Even though various embodiments and advantages of the present invention have been set forth in the foregoing description, the above disclosure is illustrative only, and changes may be made in detail and yet remain within the broad principles of the present invention. For example, although the system is described in a manufacturing environment where the remote user would typically be a remote engineer or other technical person, the virtual presence station as described above may also be applied to other applications or environments. For example, the virtual presence station could be utilized in sales, exploration, negotiating, marketing, and home security environments, with perhaps some of components on the station being modified, omitted, or added depending on the specific application, as will be appreciated by one skilled in the art. Therefore, the present invention is to be limited only by the appended claims.

1. A computer network, comprising:
a communications network;
a unit under test coupled to the communications network;
a test controller coupled to the communications network and operable to communicate over the communications network to test the unit under test; and
a virtual presence station adapted to be positioned at a desired physical location and being operable to communicate over the communications network with a remote user and with the unit under test and the test controller, the virtual presence station being operable to communicate data to the remote user that is a function of the physical position of the virtual presence station and being further operable responsive to data from the remote user to control the test controller and/or the unit under test.

2. The computer network of claim 1 wherein the virtual presence station communicates with the remote user through a virtual private network.

3. The computer network of claim 1 wherein the virtual presence station is operable to communicate, in addition to the audio and video data, emails and other digital files to the remote user.

4. The computer network of claim 1 wherein the virtual presence station comprises:
a computer including a wireless interface operable to communicate with the communications network;
a high-resolution image capture system coupled to the computer;
a low-resolution image capture system coupled to the computer;
an audio communications system coupled to the computer;
a test area adapted to receive units to be tested;
a power source coupled at least to the computer; and
a transfer apparatus adapted to hold the computer, high-resolution and low resolution image capture systems, audio communications system, test area, and power source.

5. The computer network of claim 1 wherein the test controller executes a Unix operating system and the computer executes a Windows operating system.

6. The computer network of claim 1 wherein the virtual presence station is operable to control the test controller and/or the unit under test to perform an integrated circuit test and/or a functional unit test on the unit under test.

7. The computer network of claim 1 wherein the data the virtual presence station communicates to the remote user includes audio and video data.

8. A computer network, comprising:
a local computer network, including,
a communications network;
a unit under test coupled to the communications network;
a test controller coupled to the communications network and operable to communicate over the communications network to test the unit under test; and
a virtual presence station adapted to be positioned at a desired physical location and being operable to communicate over the communications network with a remote user and with the unit under test and/or the test controller, the virtual presence station being operable to communicate data to the remote user that is a function of the physical position of the virtual presence station and being further operable responsive to data from the remote user to control the test controller and/or the unit under test; and
a remote computer network operable responsive to remote user input to communicate with the virtual presence station to control the unit under test and/or the test controller.

9. The computer network of claim 8 wherein the virtual presence station communicates with the remote computer network through a virtual private network established between the local computer network and the remote computer network.

10. The computer network of claim 8 wherein the virtual presence station is operable to communicate, in addition to the audio and video data, emails and other digital files to the remote user.

11. The computer network of claim 8 wherein the local computer network comprises a computer network at a contract manufacturer site or a configure to order site, and wherein the remote computer network comprises a corporate intranet.

12. The computer network of claim 8 wherein the remote computer network is further operable to communicate with a home computer system to allow a remote user while at home to communicate with the local computer network via the remote computer network.

13. The computer network of claim 8 wherein the test controller executes a Unix operating system and wherein the virtual presence station executes a Windows operating system.

14. The computer network of claim 8 wherein the virtual presence station is operable to control the test controller and/or the unit under test to perform an integrated circuit test and/or a functional unit test on the unit under test.

15. The computer network of claim 8 wherein the virtual presence station comprises:
a computer including a wireless interface operable to communicate with the communications network;
a high-resolution image capture system coupled to the computer;
a low-resolution image capture system coupled to the computer;
an audio communications system coupled to the computer;
a test area adapted to receive units to be tested;
a power source coupled at least to the computer; and
a transfer apparatus adapted to hold the computer, high-resolution and low resolution image capture systems, audio communications system, test area, and power source.

16. The computer network of claim 8 wherein the data the virtual presence station communicates to the remote user includes audio and video data.

17. A virtual presence station adapted to be positioned at a desired physical location and being operable to communicate over a communications network with a remote user and with a unit under test and/or a test controller, the virtual presence station being operable to communicate data to the remote user that is a function of the physical position of the virtual presence station and being further operable responsive to data from a remote user to control the test controller and/or the unit under test.

18. The virtual presence station of claim 17, comprising:
a computer including a wireless interface operable to couple the computer to a computer network;
a high-resolution image capture system coupled to the computer;
a low-resolution image capture system coupled to the computer;
an audio communications system coupled to the computer;
a test area adapted to receive units to be tested;
a power source coupled at least to the computer; and
a transfer apparatus adapted to hold the computer, high-resolution and low resolution image capture systems, audio communications system, test area, and power source.

19. The virtual presence station of claim 18 wherein the high-resolution image capture system comprises a digital camera.

20. The virtual presence station of claim 18 wherein the low-resolution image capture system comprises a network Web camera.

21. The virtual presence station of claim 18 wherein the power source comprises a battery.

22. The virtual presence station of claim 18 wherein the audio communications system comprises a wireless telephone.

23. The virtual presence station of claim 22 wherein the wireless telephone includes speaker phone functionality and wherein the audio communications system further comprises a wireless headset coupled to the wireless telephone.

24. The virtual presence station of claim 18 wherein the computer comprises a laptop.

25. The virtual presence station of claim 18 wherein the test area comprises an electrostatic discharge mat and grounding device.

26. The virtual presence station of claim 25 further comprising a light coupled to the transfer apparatus, the light operable to illuminate the test area.

27. The virtual presence station of claim 18 wherein the transfer apparatus comprises a portable cart having wheels adapted to allow the cart to be transported from one location to another.

28. The virtual presence station of claim 18 wherein the data communicated to the remote user includes audio and video data.

29. A method of remotely testing units under test at a local site by a person at a remote site, the method comprising:
positioning a portable station at a desired location at the local site;
providing to the remote site information relating to the units being tested, the information being a function of the position of the station; and
communicating with the portable station from the remote site to test the units under test.

30. The method of claim 29 wherein communicating with the portable station from the remote site comprises communicating with personnel at the local site via the station to test the units under test.

31. The method of claim 28 wherein real-time audio is provided via a computer network including the Internet and wherein the real-time video is provided by a network Web camera via computer network including the Internet.

32. The method of claim 28 wherein the information comprises audio and video information.
